(19) United States
(12) Patent Application Publication
(10) Pub. No.: US 2025/0192177 A1
(43) Pub. Date: Jun. 12, 2025

(54) METAL OXIDE AND MIXED METAL OXIDE COATINGS ON CATHODE ACTIVE MATERIAL USING ISOPROPOXIDE PRECURSOR

(71) Applicant: GM GLOBAL TECHNOLOGY OPERATIONS LLC, Detroit, MI (US)

(72) Inventors: Vamakshi YADAV, Sterling Heights, MI (US); Raneen TAHA, Sterling Heights, MI (US); Devendrasinh DARBAR, Sterling Heights, MI (US); Zhongyi LIU, Troy, MI (US)

(21) Appl. No.: 18/535,004

(22) Filed: Dec. 11, 2023

(51) Int. Cl. H01M 4/62; H01M 4/02; H01M 4/04

(52) U.S. Cl. CPC H01M 4/62; H01M 4/0471; H01M 2004/028

(57) ABSTRACT

A method for manufacturing a cathode electrode including a) dissolving one or more first organic isopropoxide precursors in a first solvent to form a mixture; b) adding particles of cathode active material to the mixture; c) heating and stirring the mixture to a first predetermined temperature for a first predetermined period to form a first metal oxide coating on the particles of the cathode active material; d) filtering the particles of the cathode active material from the mixture; and e) calcining the particles of the cathode active material at a second predetermined temperature for a second predetermined period.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a method using one or more organic isopropoxide precursors to form a single-, bi-, or multi-metal oxide coatings on particles of cathode active material.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A method for manufacturing a cathode electrode including a) dissolving one or more first organic isopropoxide precursors in a first solvent to form a mixture; b) adding particles of cathode active material to the mixture; c) heating and stirring the mixture to a first predetermined temperature for a first predetermined period to form a first metal oxide coating on the particles of the cathode active material; d) filtering the particles of the cathode active material from the mixture; and e) calcining the particles of the cathode active material at a second predetermined temperature for a second predetermined period.

In other examples, the first predetermined temperature is in a range from 80° C. to 250° C. The second predetermined temperature is in a range from 300° C. to 550° C.

In other examples, the one or more first organic isopropoxide precursors are selected from a group consisting of aluminum (Al), titanium (Ti), niobium (Nb), zirconium (Zr), strontium (Sr), tin (Sn), barium (Ba), lithium (Li), antimony (Sb), lanthanum (La), samarium (Sm), germanium (Ge), gadolinium (Gd), yttrium (Y), scandium (Sc), boron (B), and cerium (Ce). The cathode active material is selected from a group consisting of lithium- and manganese-rich (LMR), lithium iron phosphate (LFP), lithium manganese iron phosphate (LMFP), lithium nickel cobalt manganese aluminum (NCMA), lithium nickel manganese cobalt (NMC), lithium nickel oxide (LNO), lithium manganese oxide (LMO), and combinations thereof.

In other examples, the one or more first organic isopropoxide precursors include a single organic isopropoxide precursor and the first metal oxide coating on the particles of the cathode active material includes a single-metal oxide coating.

In other examples, the one or more first organic isopropoxide precursors include N organic isopropoxide precursors and the first metal oxide coating on the particles of the cathode active material include an N-metal oxide coating, where N is an integer greater than one.

In other examples, the first metal oxide coating on the particles of the cathode active material have a thickness in a range from 2 nm to 50 nm.

In other examples, the first metal oxide coating on the particles of the cathode active material have a thickness in a range from 5 nm to 20 nm.

In other features, after d) and before e), f) rinsing the particles of the cathode active material including the first metal oxide coating; g) creating a mixture by adding one or more second organic isopropoxide precursors to a second solvent; h) stirring the mixture until the one or more second organic isopropoxide precursors dissolve; i) adding the particles of the cathode active material including the first metal oxide coating to the mixture; j) heating the mixture to the first predetermined temperature for the first predetermined period to form a second metal oxide coating on the particles of the cathode active material; and k) filtering the particles of the cathode active material from the mixture.

In other features, the method includes washing the particles of the cathode active material and drying the particles of the cathode active material after d) and before e). The first metal oxide coating includes a single metal oxide selected from a group consisting of Al, Ce, Ti, Sr, and Ge. The first metal oxide coating includes a dual metal oxide selected from a group consisting of Li—Ce, Li—Zr, Ce—Al, Gd—Al, Gd—Ce, Sb—Al, Sb—Ce, Ge—Al, and Ge—Ce.

In other features, a metal in the first metal oxide coating is less conductive than a metal oxide in the second metal oxide coating. A first metal oxide in the first metal oxide coating is selected from a group consisting of Ce, Al, and Zr and a second metal oxide in the second metal oxide coating is selected from a group consisting of Li, Gd, Sb, and Ge.

A method manufacturing a cathode electrode includes a) dissolving one or more organic isopropoxide precursors in solvent to form a mixture, wherein the one or more organic isopropoxide precursors are selected from a group consisting of aluminum (Al), titanium (Ti), niobium (Nb), zirconium (Zr), strontium (Sr), tin (Sn), barium (Ba), lithium (Li), antimony (Sb), lanthanum (La), samarium (Sm), germanium (Ge), gadolinium (Gd), yttrium (Y), scandium (Sc), boron (B), and cerium (Ce); b) adding particles of cathode active material to the mixture, wherein the cathode active material is selected from a group consisting of lithium- and manganese-rich (LMR), lithium iron phosphate (LFP), lithium manganese iron phosphate (LMFP), lithium nickel cobalt manganese aluminum (NCMA), lithium nickel manganese cobalt (NMC), lithium nickel oxide (LNO), lithium manganese oxide (LMO), and combinations thereof; c) heating the mixture to a first predetermined temperature in a range from 80° C. to 250° C. for a first predetermined period to form a metal oxide coating on the particles of the cathode active material; d) filtering the particles of the cathode active material from the mixture; and e) calcining the particles of the cathode active material at a second predetermined temperature in a range from 300° C. to 550° C. for a second predetermined period.

In other features, the one or more organic isopropoxide precursors comprise aluminum (Al) and titanium (Ti). The metal oxide coating has a thickness in a range from 2 nm to 50 nm. The metal oxide coating has a thickness in a range from 5 nm to 20 nm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrode, and separators according to the present disclosure;

FIG. 2 is a side cross sectional view of an example of a cathode electrode with cathode active material that is coated using one or more organic isopropoxide precursors to form a single-, bi-, or multi-metal oxide coating according to the present disclosure;

FIG. 3A is an enlarged view of an example of the cathode active material with a single-, bi-, or multi-metal oxide coating according to the present disclosure;

FIG. 3B is an enlarged view of an example of the cathode active material with first and second single-, bi-, or multi-metal oxide coatings according to the present disclosure;

FIG. 4 is a flowchart of an example of a method for coating cathode active material using one or more organic isopropoxide precursors to form a single-, bi-, or multi-metal oxide coating according to the present disclosure; and

FIG. 5 is a graph illustrating an example of discharge capacity and discharge capacity retention percentage for coated and uncoated cathode active material according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Lithium- and manganese-rich (LMR) layered oxides exhibit higher specific capacity than commercial LFP- and NMC-based cathode materials. However, detrimental reactions at the cathode-electrolyte interface reduce cycling stability of the LMR cathode electrodes. Constructing artificial barriers to mitigate these undesired interactions improves cycle life of LMR cathode materials.

The present disclosure relates to a method for coating cathode active material using one or more organic metal oxide precursors to create a single-, bi, or multi-metal oxide coating (e.g., Al—TiOₓ) on particles of the cathode active material. In some examples, the metal oxide coating includes a single coating with one or more metal oxides. In other examples, the metal oxide coating includes a two or more coatings each with one or more metal oxides.

For example, the metal oxide coating includes a single coating with two metal oxide species (e.g., Al—TiOₓ). For example, it is believed that the first metal ions (e.g., aluminum ions (Al³⁺)) penetrate the surface of the cathode active material while second metal ions (e.g., titanium ions (Ti⁴⁺)) remain on the surface of the cathode active material. In the absence of water/alcohol, the organic isopropoxide precursors remain intact and prevent nucleation of unbound/free metal oxide nanoparticles in solution. Unlike nanoparticles or colloidal solutions, two or more molecular metal precursors mixed in solution facilitate uniform deposition of these metals across the metal oxide coating.

The method according to the present disclosure enables a simple process for single-, bi- or multi-metal oxide coating of particles of cathode active material. The thickness of the metal oxide coating can be tuned by creating surface terminations such as hydroxides (—OH) that allow for further reaction with isopropoxide precursors.

In some examples, one or more organic isopropoxide precursors are selected from a group consisting of aluminum (Al), titanium (Ti), niobium (Nb), zirconium (Zr), strontium (Sr), tin (Sn), barium (Ba), lithium (Li), antimony (Sb), lanthanum (La), samarium (Sm), germanium (Ge), gadolinium (Gd), yttrium (Y), scandium (Sc), boron (B), and cerium (Ce). The method can be used to produce one or more single-metal or mixed-metal coatings with any of the above metal precursors.

In some examples, the metal oxide coating thickness is in the range from 2 nm to 50 nm. In other examples, the metal oxide coating thickness is in the range from 5 nm to 20 nm. In some examples, metal weight loading is in a range from 0.01 wt % to 2 wt. % of the cathode active material. Large scale coating can be performed using solution-batch synthesis and/or a continuous stirred-tank reactor.

In some examples, the cathode active material is selected from a group consisting of lithium- and manganese-rich (LMR), lithium iron phosphate (LFP), lithium manganese iron phosphate (LMFP), lithium nickel cobalt manganese aluminum (NCMA), lithium nickel manganese cobalt (NMC), lithium nickel oxide (LNO), lithium manganese oxide (LMO), and combinations thereof.

In some examples, modifications to the metal oxide coating process can include sequential deposition of metal precursors. In some examples, the coated material is washed (e.g., with water or solvent) and the process is repeated with the same or different organic isopropoxide precursors to increase coating thickness and/or to create a multi-metal oxide coating.

In some examples, the metal oxide coating includes a single metal oxide selected from a group consisting of Al, Ce, Ti, Sr, and Ge. In some examples, the metal oxide coating includes a dual metal coating selected from a group consisting of Li—Ce, Li—Zr, Ce—Al, Gd—Al, Gd—Ce, Sb—Al, Sb—Ce, Ge—Al, and Ge—Ce.

In some examples, two sequential coatings having different compositions are used. In some examples, the solution of a first metal precursor and the cathode active material is heated and stirred. After a predetermined period, the solution is filtered and rinsed with a solvent such as acetone and/or ethanol. The coated cathode active material is air dried at a predetermined temperature for a predetermined period. In some examples, the predetermined temperature is in a range from 70° C. to 150° C. (e.g., 80 C) and the predetermined period is in a range from 12 to 24 h. The dried coated cathode active material is added to a second metal precursor solution and the process continues as described above.

In some examples, the metal oxide in the first metal oxide coating is less conductive than the metal oxide in the second metal oxide coating. In some examples, the first metal in the first metal oxide coating is selected from a group consisting of Ce, Al, Zr and the second metal in the second metal oxide coating is selected from a group consisting of Li, Gd, Sb, Ge.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46.

In some examples, the cathode active material layers 24 and/or the anode active material layers 42 comprise coatings including one or more active materials, one or more conductive additives, and/or one or more binder materials that are applied to the current collectors. In some examples, the A anode electrodes 40 and the C cathode electrodes 20 exchange lithium ions during charging/discharging. The cathode active material layers 24 include cathode active material that is coated with one or more metal oxide coatings as described herein.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

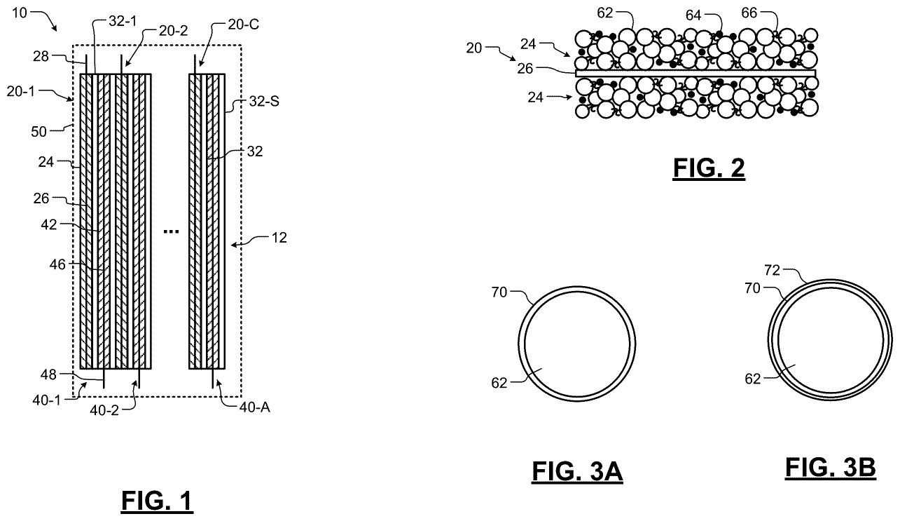

Referring now to FIG. 2, one of the C cathode electrodes 20 is shown in more detail. The cathode active material layer 24 of the one of the C cathode electrodes 20 includes a coated cathode active material 62, an optional conductive additive 64, and an optional binder 66. In some examples, the cathode active material 62 is coated using one or more organic isopropoxide precursors to form one or more single-, bi-, or multi-metal oxide coating on the particles of the cathode active material.

In some examples, the cathode active material 62 is selected from a group consisting of lithium- and manganese-rich (LMR), lithium nickel manganese cobalt oxide (NMC), nickel cobalt manganese aluminum (NCMA), lithium iron phosphate (LFP), lithium nickel oxide (LNO), lithium manganese iron phosphate (LMFP), lithium manganese oxide (LMO), and combinations thereof.

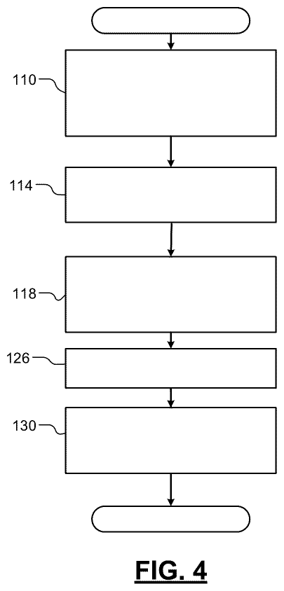

In FIG. 3A, the cathode active material 62 is coated with a first metal oxide coating 70 including one or more metal oxides. The first metal oxide coating 70 is produced using one or more organic isopropoxide precursors to form a single-, bi-, or multi-metal oxide coating on particles of the cathode active material 62. In FIG. 3B, the cathode active material 62 is coated with the first metal oxide coating 70 including one or more metal oxides and a second metal oxide coating 72 including one or more metal oxides.

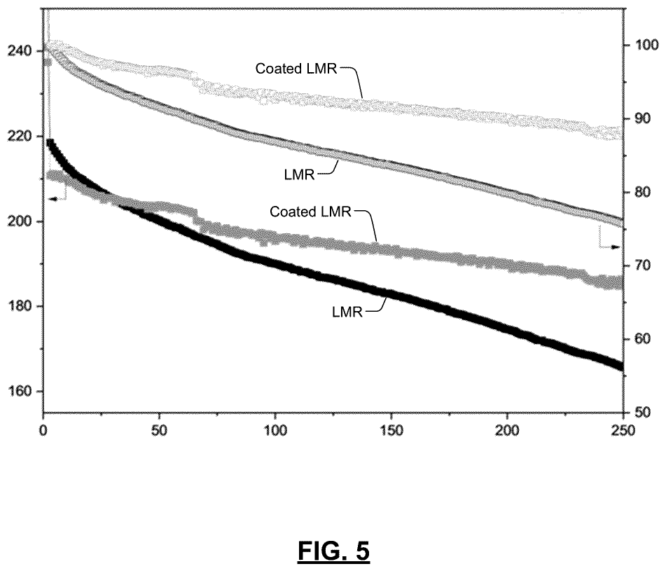

Referring now to FIG. 4, a method for manufacturing the cathode material is shown. One or more organic isopropoxide precursor(s) are dissolved in solvent such as toluene and stirred at a first predetermined temperature (e.g., room temperature) at 110. At 114, cathode active material powder is added to the solution and stirred for a first predetermined period. In some examples, the first predetermined period is in a range from 30 minutes to 24 hours (e.g., 12 hours).

At 118, the mixture is heated to a second predetermined temperature for a second predetermined period and then cooled (e.g., to room temperature). In some examples, the first predetermined temperature is in a range from 80° C. to 250° C. (e.g., 150° C.). In some examples, the first predetermined period is in a range from 10 minutes to 3 hours (e.g., 1 hour).

At 126, the mixture is filtered to recover solids. The solids are washed with solvent and then dried. At 130, the solids are calcined at a second predetermined temperature for a second predetermined period. In some examples, the second predetermined temperature is in a range from 300° C. to 550° C. (e.g., 450° C.). In some examples, the second predetermined period is in a range from 10 minutes to 5 hours (e.g., 2 hours).

For example, aluminum isopropoxide and titanium isopropoxide are dissolved in toluene and stirred at room temperature. Once the metal precursors are dissolved, cathode active material powder is added to the solution and stirred at room temperature for 12 h. The mixture is heated at 150° C. for 1 h and subsequently cooled to room temperature. Solids are recovered by filtering the solution. The solids are washed with acetone and dried (e.g., air dried). The dried solid is calcined at 450° C. for 2 h and subsequently used in a cathode active material layer.

Referring now to FIG. 5, discharge capacity and discharge capacity retention percentage for coated and uncoated cathode active material including LMR is shown. The operating voltage window is in a range from 2V to 4.6V at C/3. The battery cell includes cathode electrodes including LMR/carbon black/PVDF having a 94/3/3 ratio. The anode electrode comprises 5.5% SiOₓ-graphite. Electrode loading was ˜5 mAh/cm² positive capacity and 5.5 mAh/cm² negative capacity. Active mass loading on the cathode electrode was 24 to 25 mg/cm². The diameter of the cathode was 12.7 mm. As can be seen, the coated LMR exhibits improved discharge capacity and discharge capacity retention percentage.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a cathode electrode, comprising:
a) dissolving one or more first organic isopropoxide precursors in a first solvent to form a mixture;
b) adding particles of cathode active material to the mixture;
c) heating and stirring the mixture to a first predetermined temperature for a first predetermined period to form a first metal oxide coating on the particles of the cathode active material;
d) filtering the particles of the cathode active material from the mixture; and
e) calcining the particles of the cathode active material at a second predetermined temperature for a second predetermined period.

2. The method of claim 1, wherein the first predetermined temperature is in a range from 80° C. to 250° C.

3. The method of claim 1, wherein the second predetermined temperature is in a range from 300° C. to 550° C.

4. The method of claim 1, wherein:
the one or more first organic isopropoxide precursors are selected from a group consisting of aluminum (Al), titanium (Ti), niobium (Nb), zirconium (Zr), strontium (Sr), tin (Sn), barium (Ba), lithium (Li), antimony (Sb), lanthanum (La), samarium (Sm), germanium (Ge), gadolinium (Gd), yttrium (Y), scandium (Sc), boron (B), and cerium (Ce); and
the cathode active material is selected from a group consisting of lithium- and manganese-rich (LMR), lithium iron phosphate (LFP), lithium manganese iron phosphate (LMFP), lithium nickel cobalt manganese aluminum (NCMA), lithium nickel manganese cobalt (NMC), lithium nickel oxide (LNO), lithium manganese oxide (LMO), and combinations thereof.

5. The method of claim 1, wherein the one or more first organic isopropoxide precursors include a single organic isopropoxide precursor and the first metal oxide coating on the particles of the cathode active material includes a single-metal oxide coating.

6. The method of claim 1, wherein the one or more first organic isopropoxide precursors include N organic isopropoxide precursors and the first metal oxide coating on the particles of the cathode active material include an N-metal oxide coating, where N is an integer greater than one.

7. The method of claim 1, wherein the first metal oxide coating on the particles of the cathode active material have a thickness in a range from 2 nm to 50 nm.

8. The method of claim 1, wherein the first metal oxide coating on the particles of the cathode active material have a thickness in a range from 5 nm to 20 nm.

9. The method of claim 1, further comprising after d) and before e):
f) rinsing the particles of the cathode active material including the first metal oxide coating;
g) creating a mixture by adding one or more second organic isopropoxide precursors to a second solvent;
h) stirring the mixture until the one or more second organic isopropoxide precursors dissolve;
i) adding the particles of the cathode active material including the first metal oxide coating to the mixture;
j) heating the mixture to the first predetermined temperature for the first predetermined period to form a second metal oxide coating on the particles of the cathode active material; and
k) filtering the particles of the cathode active material from the mixture.

10. The method of claim 1, further comprising washing the particles of the cathode active material and drying the particles of the cathode active material after d) and before e).

11. The method of claim 1, wherein the first metal oxide coating includes a single metal oxide selected from a group consisting of Al, Ce, Ti, Sr, and Ge.

12. The method of claim 1, wherein the first metal oxide coating includes a dual metal oxide selected from a group consisting of Li—Ce, Li—Zr, Ce—Al, Gd-AI, Gd—Ce, Sb—Al, Sb—Ce, Ge—Al, and Ge—Ce.

13. The method of claim 9, wherein a metal in the first metal oxide coating is less conductive than a metal oxide in the second metal oxide coating.

14. The method of claim 9, wherein a first metal oxide in the first metal oxide coating is selected from a group consisting of Ce, Al, and Zr and a second metal oxide in the second metal oxide coating is selected from a group consisting of Li, Gd, Sb, and Ge.

15. A method manufacturing a cathode electrode, comprising:
a) dissolving one or more organic isopropoxide precursors in solvent to form a mixture, wherein the one or more organic isopropoxide precursors are selected from a group consisting of aluminum (Al), titanium (Ti), niobium (Nb), zirconium (Zr), strontium (Sr), tin (Sn), barium (Ba), lithium (Li), antimony (Sb), lanthanum (La), samarium (Sm), germanium (Ge), gadolinium (Gd), yttrium (Y), scandium (Sc), boron (B), and cerium (Ce);
b) adding particles of cathode active material to the mixture, wherein the cathode active material is selected from a group consisting of lithium- and manganese-rich (LMR), lithium iron phosphate (LFP), lithium manganese iron phosphate (LMFP), lithium nickel cobalt manganese aluminum (NCMA), lithium nickel manganese cobalt (NMC), lithium nickel oxide (LNO), lithium manganese oxide (LMO), and combinations thereof;
c) heating the mixture to a first predetermined temperature in a range from 80° C. to 250° C. for a first predetermined period to form a metal oxide coating on the particles of the cathode active material;
d) filtering the particles of the cathode active material from the mixture; and
e) calcining the particles of the cathode active material at a second predetermined temperature in a range from 300° C. to 550° C. for a second predetermined period.

16. The method of claim 15, wherein the one or more organic isopropoxide precursors comprise aluminum (Al) and titanium (Ti).

17. The method of claim 15, wherein the metal oxide coating has a thickness in a range from 2 nm to 50 nm.

18. The method of claim 15, wherein the metal oxide coating has a thickness in a range from 5 nm to 20 nm.
